(19) United States
(12) Patent Application Publication
(10) Pub. No.: US 2006/0152028 A1
(43) Pub. Date: Jul. 13, 2006

(54) Vehicle door having a lockable compartment

(75) Inventor: Laurent Cheramy, Vieilles-Maisons-sur-Joudry (FR)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Light Vehicle Systems - France

(21) Appl. No.: 11/324,448

(22) Filed: Jan. 3, 2006

(30) Foreign Application Priority Data
Jan. 7, 2005 (DE) 10 2005 000 987.5

(51) Int. Cl. B60R 7/04

(52) U.S. Cl. 296/37.13

(57) ABSTRACT

A vehicle door includes a lockable compartment that is movable between a closed position in which no access to an interior of the compartment is possible, and an opened position in which access to the interior of the compartment is possible. A locking mechanism locks the compartment in the closed position. The locking mechanism is coupled to a door latch so that the compartment is automatically locked when the door latch is locked.

### RELATED APPLICATIONS

The application claims priority to German Application No. 10 2005 000 987.5 which was filed on Jan. 7, 2005.

### BACKGROUND OF THE INVENTION

The invention relates to a lockable compartment that is provided in an interior of a vehicle.

It is known to provide lockable glove boxes that can be manually locked with a key. Such lockable glove boxes provide theft protection for items stored therein, for example when the vehicle is parked. Breaking a window of a parked vehicle allows access to the interior of the vehicle but, if the glove box is locked, does not allow, or at least significantly impedes, access to items contained in the glove box. Further, locking the glove box is of importance if the vehicle is a convertible that is parked with an opened top. However, as a glove box needs to be operated manually, the glove box frequently remains unintentionally in an unlocked condition. Further, conventional glove boxes are usually not very strong, which results in limited theft protection; or the glove boxes would be unaesthetic if designed to be theft resistant.

The object of the invention is to provide a lockable compartment that is easier to operate and provides better theft protection.

### SUMMARY OF THE INVENTION

This object is solved according to the invention by a vehicle door having a lockable compartment that is movable between a closed position in which no access to an interior of the compartment is possible, and an opened position in which access to the interior of the compartment is possible. A locking mechanism locks the compartment in the closed position. The locking mechanism is coupled to a door latch so that the compartment is automatically locked when the door latch is locked.

By providing the lockable compartment in the vehicle door, the door latch can be used to lock and unlock the compartment. Also, it is possible to easily use a latching status, such as unlocked, locked, and superlocked, to define the locking status of the lockable compartment. This preferably allows implementation of the invention without a separate lock for the lockable compartment. Rather, a simple mechanism, such as a locking bolt connected to the door latch with a cable or a lever mechanism, is sufficient.

Further, the lockable compartment is automatically locked each and every time a vehicle is locked. Accordingly, there is no risk of forgetting to manually lock the compartment. Finally, providing the lockable compartment in a vehicle door allows the compartment to be essentially flush with an inner door trim. This offers advantages both from an aesthetic point of view as well as concerning theft protection. A compartment terminating flush with the inner door trim does not allow exertion of high forces on the compartment, which would be required to break open the compartment when the compartment is locked.

In another embodiment, the compartment is equipped with its own latching actuator that is actuated depending on the status of the latch. In particular, the latching actuator can be actuated with an electric signal. This allows a simple electric cable to be fed from the door latch to the latching actuator of the compartment rather than a mechanical actuation mechanism. This significantly simplifies the issue of providing adequate sealing at a point where the electric cable is fed through a wet barrier located between the latch and the inner door trim. This reduces the risk of moisture penetration to the inner trim and reduces the costs for providing such seals between the mechanical actuation mechanism and the wet barrier.

According to a preferred embodiment of the invention, a push-lock mechanism used to hold the compartment in the closed position. This allows the compartment to be opened by simply pushing against the compartment door. No lever or handle is required. This is also advantageous as it provides a pleasing design with good theft protection.

The above object is also solved by a door latch that has a sensing mechanism that senses a latching condition and transmits this condition to a lockable compartment. This sensing mechanism allows a lockable compartment to be locked in an easy and simple way. The sensing mechanism could be an attachment point for a mechanical cable, an attachment point for a lever mechanism, or an electrical sensor.

These and other features of the present invention can be best understood from the following specification and drawings, the following of which is a brief description.

### BRIEF DESCRIPTION OF THE DRAWINGS

FIG. 1 shows a schematic, perspective view of essential components of a door incorporating the subject invention.

FIG. 2 shows a cross-section through a vehicle door having a lockable compartment.

FIG. 3 schematically shows a section along plane III-III identified in FIG. 1.

### DETAILED DESCRIPTION OF THE PREFERRED EMBODIMENT

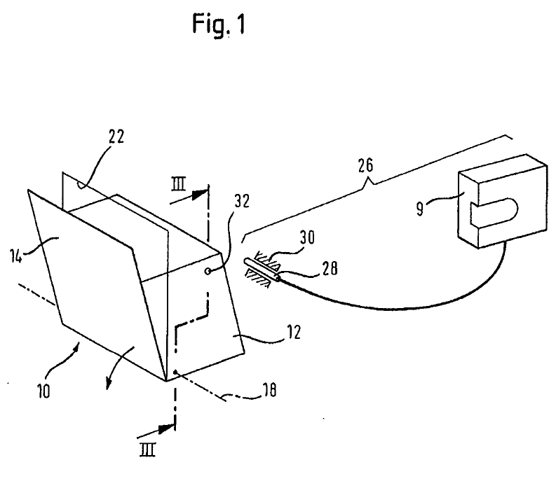

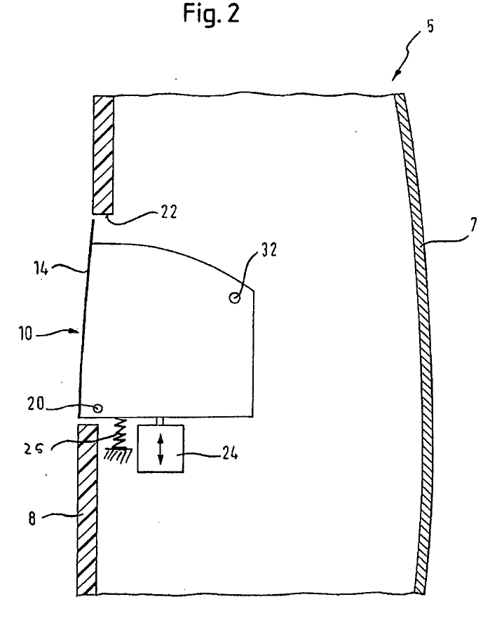

As shown in FIG. 2, a vehicle door 5 has an outer structure 7, typically made from stamped steel or a plastic material, and an inner door trim 8 that is typically made from a plastic material. In a space between the outer structure 7 and the door trim 8, various components such as a power window drive etc. can be accommodated. Attached to the vehicle door 5 is a door latch 9 (FIG. 1) that serves to hold the vehicle door 5 in a closed position on a vehicle body, and which releases the vehicle door 5. The particulars of the door latch 9 are not important to the invention. It is only to be remembered that a door latch can assume up to four conditions, namely an open condition in which the door latch does not engage the vehicle body, a closed condition in which the vehicle door is held in a closed position on the vehicle body but can be opened by actuating an inner or exterior door handle, a locked condition in which the vehicle door cannot be opened by actuating the exterior door handle but can be opened by actuating the inner door handle, and possibly a superlocked condition in which the vehicle door cannot be opened at all. For the purpose of describing the invention, the term “locked” used hereinafter and in the claims is considered to designate the conditions locked and/or superlocked.

Arranged on vehicle door 5 is a lockable compartment 10 that basically comprises a box 12 having a front plate 14, as shown in FIG. 1. Box 12 is movably mounted on the vehicle door 5 to be pivotable around a pivot axis 18 defined by studs 20 (FIG. 2). Front plate 14 is arranged within an opening 22 formed in the door trim 8 and is designed to terminate flush with an outer surface of the door trim 8, thereby closing opening 22. As can be seen by comparing FIGS. 1 and 2, compartment 10 is pivotable between a closed position (FIG. 2) in which no access to an interior of the box 12 is possible, and an opened position in which the box 12 together with front plate 14 is pivoted (when looking at FIGS. 1 and 2) in a counter-clockwise direction to allow access to the interior of the box 12.

FIG. 1 shows a partially opened position of compartment 10. The pivotal movement of the compartment 10 between the opened position and the locked position is controlled by a push-lock mechanism 24 that can hold compartment 10 in the closed position and, after compartment 10 is pivoted in a clockwise direction with regard to FIGS. 1 and 2 by some degrees, biases compartment 10 towards the opened position with a spring 25.

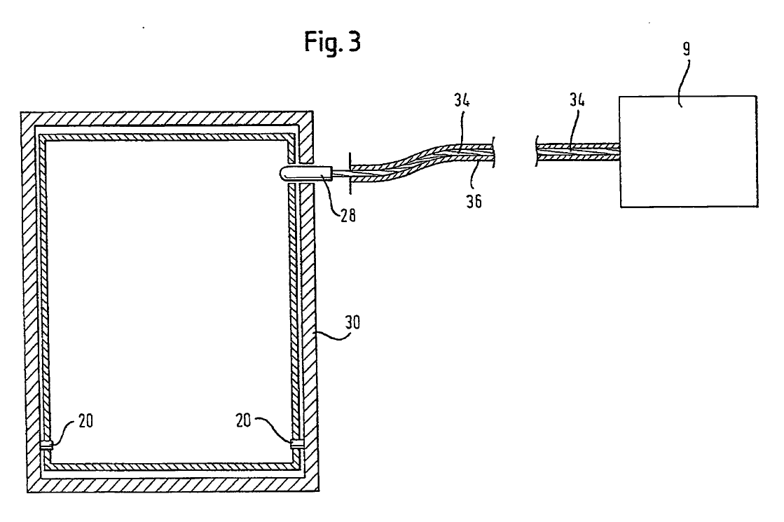

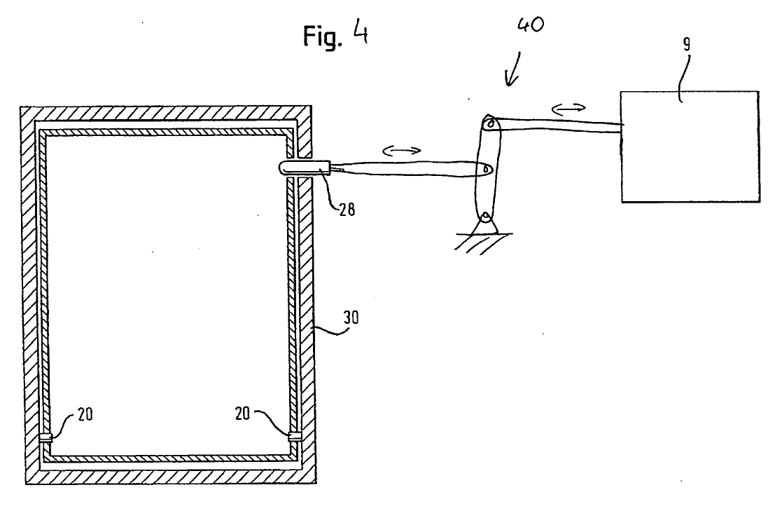

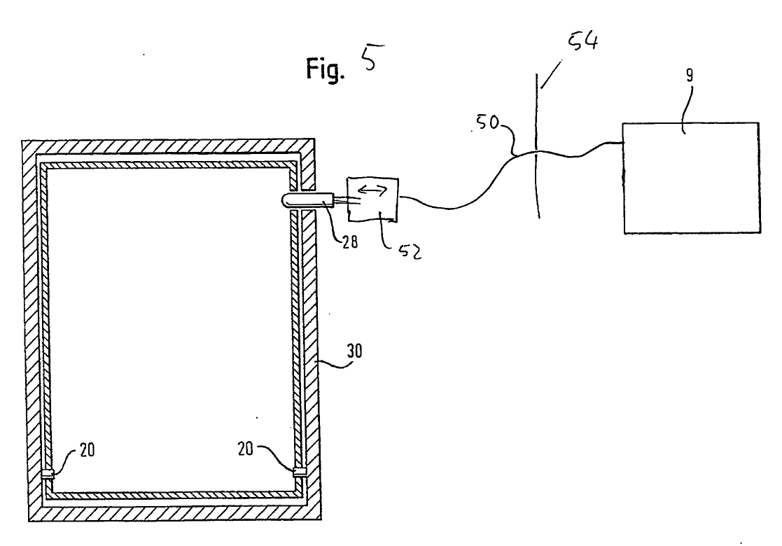

A locking mechanism 26 is provided for locking compartment 10 in the closed position. Locking mechanism 26 comprises a locking bolt 28 that is displaceably supported in a frame 30 that surrounds the compartment 10 and is part of the vehicle door 5. Box 12 is provided with a locking opening 32, the position of which coincides with a position of locking bolt 28 when compartment 10 is in the closed position. Locking bolt 28 is mechanically coupled to the door latch 9 by a Bowden cable having a cable 34 that is guided in a sheathing 36 and ends at an attachment point in door latch 9, as shown in FIG. 3.

Alternatively, a lever mechanism 40 could be used for coupling the locking bolt 28 to the door latch 9 (FIG. 4), or the door latch 9 could be provided with a sensor that signals a locking condition via an electric cable 50 to an actuator 52 associated with the locking mechanism. Using an electrical cable avoids problems which occur when a movable element is guided through a separation 54 between a wet area and a dry area of the vehicle door 5.

In the embodiment shown, cable 34 is connected to door latch 9 such that locking bolt 28 automatically assumes the position shown in FIG. 3 when the door latch 9 is in a locked condition. This results in compartment 10 also being locked so that no access to the interior of box 12 is possible. When the door latch 9 is transferred from the locked condition to the open condition, locking bolt 28 is retracted into the position shown in FIG. 1 in which the locking bolt 28 does not engage into locking opening 32. Accordingly, compartment 10 can be opened by slightly pushing against front plate 14.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A vehicle door comprising:
a lockable compartment that is movable between a closed position in which no access to an interior of the lockable compartment is possible, and an opened position in which access to the interior of the lockable compartment is possible; and
a locking mechanism that locks the lockable compartment in the closed position, the locking mechanism being coupled to a door latch so that the lockable compartment is automatically locked when the door latch is locked.

2. The vehicle door of claim 1 including a mechanical cable that couples the locking mechanism to the door latch.

3. The vehicle door of claim 1 including a lever mechanism that couples the locking mechanism to the door latch.

4. The vehicle door of claim 1 including an electric cable that couples the locking mechanism to the door latch.

5. The vehicle door of claim 1 wherein the locking mechanism comprises a locking bolt that is supported in a door structure.

6. The vehicle door of to claim 1 wherein the locking mechanism comprises an actuator.

7. The vehicle door of claim 1 wherein the lockable compartment is essentially flush with an inner door trim.

8. The vehicle door of claim 1 including a push-lock mechanism that holds the lockable compartment in the closed position.

9. The vehicle door of claim 1 including a spring that biases the lockable compartment into the opened position.

10. The vehicle door of claim 1 wherein the lockable compartment is pivotally mounted.

11. A door latch comprising:
a sensing mechanism that senses a latching condition and transmits the latching condition to a lockable compartment.

12. The door latch of claim 11 wherein the sensing mechanism is an attachment point for a mechanical cable.

13. The door latch of claim 11 wherein the sensing mechanism is an attachment point for a lever mechanism.

14. The door latch of claim 11 wherein the sensing mechanism is an electrical sensor.
